(19) United States
(12) Patent Application Publication
(10) Pub. No.: US 2006/0227450 A1
(43) Pub. Date: Oct. 12, 2006

(54) Method of configuring storage space in a data storage device

(75) Inventors: Xiong Liu, Singapore (SG); Aik Chuan Lim, Singapore (SG); Utt Heng Kan, Singapore (SG); Edmun Chian Song Seng, Singapore (SG); Choon Kiat Lim, Singapore (SG)

Correspondence Address: NIXON & VANDERHYE, PC, 901 NORTH GLEBE ROAD, 11TH FLOOR, ARLINGTON, VA, 22203, US

(73) Assignee: Seagate Technology LLC, Scotts Valley, CA (US)

(21) Appl. No.: 11/213,852

(22) Filed: Aug. 30, 2005

(30) Foreign Application Priority Data
Apr. 12, 2005 (SG) 200502319-7

(51) Int. Cl. G11B 21/02; G11B 5/86

(52) U.S. Cl. 360/75; 360/15

(57) ABSTRACT

Methods and apparatus for configuring and storing data in a data storage device to increase storage capacity while ensuring acceptable data reliability are provided. The methods may involve providing a data zone and a risk zone, which forms an outer region of the disc and is known to have a higher risk of data access failure than the data zone. The risk zone is configured to have a first location for primary data storage and a second location for storing a backup copy of the data stored in the first location.

### BACKGROUND

1. Field of the Invention

The present invention relates to data storage systems. More particularly, it relates to methods of configuring storage space in a data storage device and methods of storing data to increase data storage capacity.

2. Description of the Related Art

A data storage system, such as a disc drive, typically includes one or more data storage discs coaxially mounted to a spindle motor. The spindle motor rotates the discs while data is written to and accessed from the disc by bringing transducers or read/write heads into proximity with the surface of the rotating disc. For this purpose, an actuator assembly is used to transport the transducers. The actuator assembly includes one or more rotatable arms. At a distal end of the rotatable arm, a slider supporting the transducers is attached to the arm. The rotatable arm is driven by a voice coil motor to pivot the arm back and forth across the disc surface.

Slider movements over the disc surface are a fundamental concern because any undesired movement of the slider may cause a collision between the slider and the disc surface, thereby causing data corruption or loss or possibly even causing enough damage to render the entire disc unusable. A collision may also generate debris, which can be tossed around, thereby further damaging the disc surface and resulting in further data corruption or loss.

To prevent the collisions, a ramp system is typically provided for parking or unloading the arm when the data storage system is not in operation. In a disc drive, a ramp may be positioned proximate to an outer region of the disc. The rotatable arm of the actuator assembly may include an extension or a lift tab suitable for engaging the ramp so that the arm is secured to the ramp in the parked or unloaded position.

During the parking or unloading process, the rotatable arm is pivoted towards the outer region of the disc until the tab meets the foot of the ramp. Thereafter, the tab slides up the ramp until the slider is lifted away from the disc surface. To prevent the tab from sliding back to the disc surface, a detent or latch may be provided on the ramp to secure the tab in the parked position. In addition, the tab is retained on the ramp by static friction between the tab and the ramp surface. When access to the disc is desired, a loading process moves the tab from the detent and subsequently the transducer over the disc surface.

The slider is most at risk of collision with the disc surface when the tab is departing the ramp during a loading process or when the tab is at the foot of the ramp during the unloading process. Therefore, to ensure data reliability, the outer region of the disc, where risk of data access failure is deemed too high, is usually provided or designated as a risk zone where no data is stored.

Although the designation of a risk zone ensures data integrity, data storage and access efficiencies of the disc are reduced. This is particularly true because the outer region of the disc contains more storage capacity than other regions. In addition, a transducer positioned at the outer region of a disc is able to access more data sectors than at other regions of a disc within the same period of time.

Unfortunately, manufacturers of data storage systems have been unable to reconcile the higher efficiencies of data access and storage with the higher risks of data access failure. Because loss of important or irreplaceable data is unacceptable, data reliability is of paramount importance. Therefore, data storage systems manufacturers are compelled to designate the outer region of a disc as a risk zone, where no data will be stored.

Because of efforts to miniaturize electronic components, data storage devices have undergone extensive reduction in form factor, unfortunately resulting in a greater percentage of unusable risk zone areas in the discs. For example, in 1-inch form factor disc drives, the risk zone would form a higher ratio of usable storage space as compared to a 3.5-inch form factor disc drive. This results in less efficient use of storage space and significant loss of usable storage capacity.

In view of the foregoing, it is desirable to have an improved data storage disc that is more efficient in data access and storage performance, and has an increased storage capacity without compromising data reliability.

### SUMMARY OF THE INVENTION

Embodiments of the present invention provide methods and apparatus configured to increase usable storage space for storing data. These may include configuring data storage devices so that data may be stored at more than one location within a risk zone, that is, a zone associated with higher risk of data access failures as compared to another zone in the same data storage device. Preferably, the locations designated to store the same data are physically apart from one another. The data storage devices may be further configured to assign different priorities to the utilization of the one or more risk zones and to other zones capable of storing data.

Embodiments of the present invention are particularly advantageous because storage capacity can be increased easily. For example, in a disc drive, as much as five to ten percent increase in storage capacity can be achieved for each side of a 1-inch disc without increasing the physical size of the disc or decreasing product reliability.

### BRIEF DESCRIPTION OF THE DRAWINGS

Embodiments of the present invention will be readily understood by the following detailed description in conjunction with the accompanying drawings. To facilitate this description, like reference numerals designate like structural elements.

FIG. 1 is a schematic overview of a data storage system example suitable for use in accordance with embodiments of the present invention.

FIG. 2 is a partial view of a data storage disc having a data zone and a risk zone.

FIGS. 3A and 3B illustrate examples of data sectors and backup sectors in the risk zone.

FIG. 4 illustrates logical block addressing of the data zone and risk zone.

FIG. 5 illustrates a flow sequence of storing data in a data storage disc in accordance with embodiments of the present invention.

### DETAILED DESCRIPTION

In the following description, numerous specific details are set forth in order to provide a thorough understanding of various embodiments of the present invention. It will be understood, however, to one skilled in the art, that embodiments of the present invention may be practiced without some or all of these specific details. In other instances, well known process operations have not been described in detail in order not to unnecessarily obscure pertinent aspects of embodiments being described.

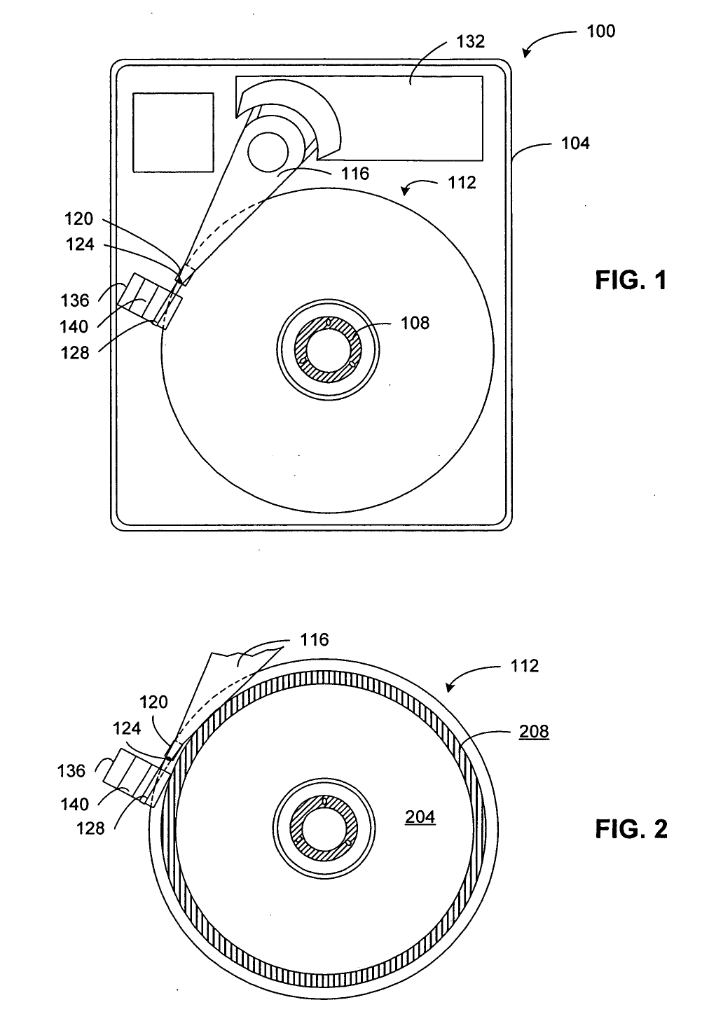

FIG. 1 illustrates a schematic overview of a data storage system 100 that can be used in accordance with embodiments of the present invention. The data storage system 100 includes a housing 104, a spindle motor 108 coupled to the housing and a data storage disc 112 rotatably mounted on the spindle motor 108. If desired, more than one disc may be mounted on the motor to form a disc stack assembly.

An actuator assembly includes one or more rotatable arms 116. At a distal end of the rotatable arm 116, a slider 120 supporting the transducers 124 is mounted to the arm 116. An extension or lift tab 128 may extend from the distal end of the arm 116 for releasable engagement with a ramp 136. The rotatable arm 116 may be driven by a voice coil motor 132, to pivot the arm 116 over various areas of the disc surface to bring the transducers 124 into proximity with different tracks and/sectors on the disc surface for reading and writing data to the data storage device. Circuitry, including a controller, may be coupled to the actuator assembly and the spindle motor 108 to control the operations of the data storage device.

When the transducers 124 are not in operation (for example, not reading or writing data), the slider 120 may be unloaded from the disc and parked by a ramp system 136. This way, the slider 120 is physically restrained and will not unintentionally contact the disc surface. The ramp system 136, which is typically located next to an outer region of the disc 112, may include a slope surface for lifting the tab 128 away from the disc surface and a detent 140 for retaining the tab 128 in a parked position.

In conventional data storage systems, the outer region of the storage disc 112 is known to have an unacceptable risk of data access failure because it is the region that is most susceptible to accidental collision with the slider 120. Since collision of the slider 120 with the disc surface will cause data corruption or data loss, storing data in this area reduces the data integrity of the storage system. Accordingly, the outer region is usually provided as a risk zone where no data will be stored. Depending on the size of the slider 120 and the storage disc 112, the dimensions of the risk zone can vary.

FIG. 2 illustrates a disc 112 providing or having designated a center aperture for mounting to a spindle motor 108, a data zone 204 at an inner or central region of the disc 112, a risk zone 208 at an outer region of the disc 112 and an edge along the circumference of the disc 112. The risk zone 208 is also known as load/unload guardband and includes the area on an outer region of a disc 112, where the transducers 124 are loaded or unloaded to the disc 112. Hence, the risk zone 208 is known to have a higher risk of data access failure than the data zone 204. Due to the normal manufacturing variations and the arrangement of transducers 124 on a slider 120, the edge of the disc 112 is usually not suitable for data storage.

In an embodiment of the present invention, data may be stored in the risk zone 208. Reliability of data stored in the risk zone 208 may be enhanced by creating a copy of the data stored for backup purposes. Should data corruption or loss occur to the data stored in the risk zone 208, the backup copy can be utilized instead. To achieve this result, the data storage system is configured to write data to a first location in the risk zone 208 for primary storage, and to write the same data to a second location for providing a backup to the data.

A disc 112 may be configured to store data in a series of concentric, closely spaced tracks, each of which is divided into sectors. The data storage system of some embodiments of the present invention may be configured to write same data to two locations using any of several exemplary methods described as follows.

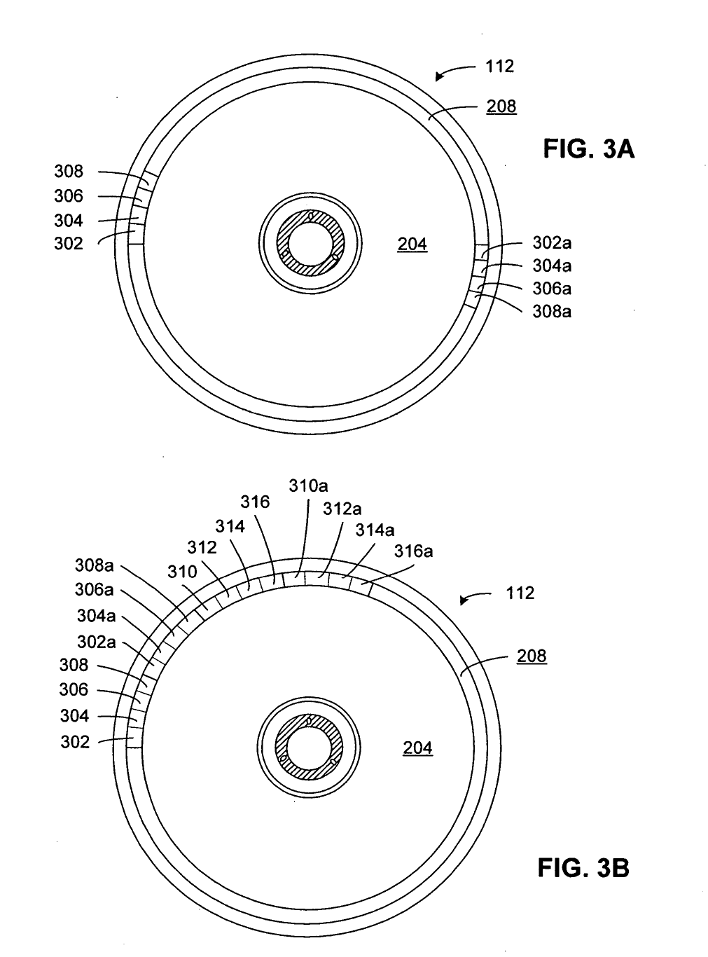

FIG. 3A illustrates a method for dividing a circular track within the risk zone 208 into two areas, each corresponding to about half track length. A first area is designated for primary data storage and contains a series of primary data storage sectors (302, 304, 306, 308, etc.). The second area is designated for backup or secondary data storage and contains a series of backup data storage sectors (302a, 304a, 306a, 308a, etc.).

In the implementation of FIG. 3A, the backup sector to a primary storage sector is non-contiguous. Since damage caused by a single collision of slider 120 with a disc surface is typically confined to a sector length, i.e., 512 bytes, having the backup copy stored in a non-contiguous sector enhances data reliability. Further, by arranging the primary data storage and backup sectors apart by about half track length, i.e., approximately across the diameter of the disc 112, significantly reduces the probability of losing both the primary storage and backup data should the slider 120 collide with the disc surface.

FIG. 3B illustrates a method for dividing a track in the risk zone 208 into more than two areas. Each area contains a series of primary data storage or backup data storage sectors. The areas form an alternating series of primary data sectors (302, 304, 306, 308, 310, 312, 314, 316, etc.) or backup sectors (302a, 304a, 306a, 308a, 310a, 312a, 314a, 316a, etc.). In this implementation, the backup sector corresponding to a primary storage sector is non-contiguous and spaced apart by at least several sectors. This arrangement is also advantageous because the primary storage and backup sectors are non-contiguously arranged and therefore damage sustained by a primary storage sector is not likely to affect the corresponding backup sector.

Other embodiments of the present invention include a method to assign backup data storage sectors in a track within the risk zone 208 and different from the corresponding primary data storage sectors. In the above embodiments, the primary data storage sectors and the backup sectors may be located on a same surface on the disc 112. Alternatively, a first risk zone may be provided or designated on a first disc surface for primary data storage, and a second risk zone may be provided or designated on a second or opposing disc surface to the first disc surface for backup data storage. Accordingly, the primary data storage sectors are located within the first risk zone, while the backup sectors for storing backup data are located within the second risk zone. This method may be used if the disc 112 is configured for writing data to both surfaces.

By creating a backup copy for data stored in the risk zone 208, data reliability of the risk zone 208 is enhanced. In the unfortunate event that certain data stored in the risk zone 208 is corrupted or lost, the backup copy can be retrieved and substituted for the lost data.

In another embodiment of the present invention, field exposure of the risk zone 208 is minimized by fully utilizing the data zone 204 before storing data in the risk zone 208. In other words, the data zone 204 may be assigned a first or higher priority for data storage purposes while the risk zone 208 may be assigned a second or lower priority. Data is stored in the risk zone 208 only when the data zone 204 is fully utilized. This approach minimizes the failure probability of data stored in the risk zone 208.

To implement this approach, Logical Block Addressing (LBA) is used to address logical sectors in the disc 112. A first set of logical block addresses is assigned to the data zone 204 and a second set of logical block addresses is assigned to the risk zone 208. To ensure priority of the data zone 204 over the risk zone 208 for data storage, each of the second set of addresses is greater than each of the first set of addresses.

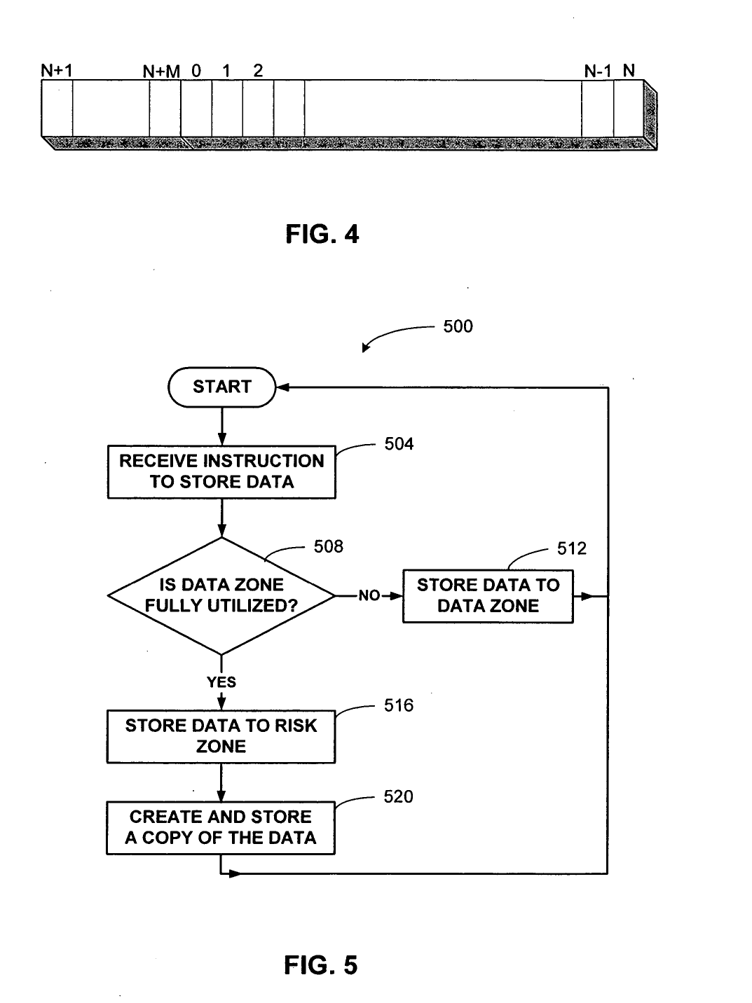

FIG. 4 illustrates assignment of logical block addresses to the data zone 204 and the risk zone 208. Logical block addresses ranging from zero to N are assigned to the data zone 204; thereafter, block addresses ranging from N+1 to N+M are assigned to the risk zone 208. Using LBA method to address sectors in the data zone 204 followed by sectors in the risk zone 208, the data zone 204 has a higher data storage priority than the risk zone 208. This ensures that the storage capacity of the data zone 204 is fully utilized before subsequent data is stored in the risk zone 208. Thus, by remapping the risk zone 208 as the last storage area of a disc 112, field exposure of the risk zone 208 is minimized.

According to yet another embodiment of the present invention, a method of storing data in a risk zone 208 is provided. The method can be summarized by a flow sequence illustrated in FIG. 5. The sequence 500 begins at a block 504 when the data storage system receives an instruction to store an incoming data to the disc 112. Thereafter, the data zone 204 is ascertained to see if it is full and has reached its maximum storage capacity at block 508. This may be accomplished, for example, by determining whether the data sector at the maximum logical block address of the data zone 204 has been utilized. If the data zone 204 has not reached its maximum capacity, the incoming data is stored in the data zone 204 in a block 512. If the data zone 204 has reached its maximum capacity, the incoming data is stored in the risk zone 208 in a block 516. At the same time, a copy of the data is generated and stored for backup purposes in a block 520.

It should be appreciated that most operating systems store data to sectors having smaller logical block addresses before storing data to sectors with greater or higher logical block addresses. Hence, in the foregoing description, the data zone 204 has a higher priority than the risk zone 208 for data storage, and is fully utilized for storing data before the risk zone 208 is subsequently used for storing data. However, certain operating systems may choose to operate in the reverse manner, i.e., storing data to sectors having greater or higher logical block addresses before storing data to sectors with smaller logical block addresses.

When such an operating system is used in conjunction with the present invention, it should be appreciated that the risk zone 208 may be utilized for storing data before the data zone 204. The addresses of the data zone 204 and the risk zone 208 may also be swapped to accommodate the operating system and preserve data zone priority. In each scenario, data reliability of the risk zone 208 can still be ensured by generating and storing a backup to the data stored in the risk zone 208 according to the present invention.

According to embodiments of the present invention, the risk zone 208 can be partially or fully utilized for data storage purposes. Even within the risk zone 208, different areas may have different levels of risk for data access failure. Generally, areas in the risk zone 208 nearer to the ramp 136, where the arm 116 is loaded to or unloaded from the disc surface have higher risks of data access failure than areas further from the ramp 136. Hence, manufacturers of data storage systems may choose to utilize the risk zone 208 partially, such as only seventy percent of the risk zone 208. Even with the partial utilization of the risk zone 208 for data storage, it would be appreciated that storage capacity of the data storage system can be significantly increased. For a one-inch form factor disc drive, the increase in storage capacity can range from about five to about ten percent.

Other embodiments will be apparent to those skilled in the art from consideration of the specification and practice of the present invention. Furthermore, certain terminology has been used for the purposes of descriptive clarity, and not to limit the present invention. The embodiments and preferred features described above should be considered exemplary, with the present invention being defined by the appended claims.

What is claimed is:

1. A method of configuring a data storage disc, comprising:
providing a data zone of the data storage disc;
providing a risk zone of the data storage disc, wherein the risk zone is associated with a higher risk of data access failure than the data zone;
designating a first location within the risk zone for storing data; and
designating a second location within the risk zone for storing a copy of the data stored in the first location.

2. The method of claim 1, wherein the second location is non-contiguous to the first location.

3. The method of claim 2, wherein the first location and the second location are located on a same surface of the data storage disc.

4. The method of claim 2, wherein providing the risk zone includes providing a first risk zone and a second risk zone, wherein the second risk zone is located on an opposing disc surface to the first risk zone and wherein the first location is within the first risk zone and the second location is within the second risk zone.

5. The method of claim 1, further comprising:
assigning a first priority for storing data to the data zone; and
assigning a second priority for storing data to the risk zone, wherein the second priority is lower than the first priority.

6. The method of claim 1, further comprising assigning a first set of addresses to the data zone and assigning a second set of addresses to the risk zone, wherein each of the second set of addresses is greater than each of the first set of addresses.

7. The method of claim 1, wherein the risk zone is located at an outer region of the data storage disc.

8. A method of storing data in a data storage device, comprising:
providing a data zone;
providing a risk zone, wherein the risk zone is associated with a higher risk of data access failure than the data zone;
assigning a first set of addresses to the data zone;
assigning a second set of addresses to the risk zone, wherein each of the second set of addresses is greater than each of the first set of addresses; and
storing data in the risk zone.

9. The method of claim 8, wherein storing data in the risk zone includes storing the data in a first location within the risk zone and storing a copy of the data in a second non-contiguous location within the risk zone.

10. The method of claim 9, wherein the first location and the second location are located on a same surface of a data storage disc.

11. The method of claim 9, wherein providing the risk zone includes providing a first risk zone and a second risk zone located on an opposing disc surface to a disc surface containing the first risk zone, wherein the first location is within the first risk zone and the second location is within the second risk zone.

12. The method of claim 9, wherein storing data in the risk zone includes storing the data in the risk zone only when the data zone is fully utilized.

13. The method of claim 9, wherein storing data in the risk zone includes storing the data in the risk zone before the data zone is utilized.

14. A data storage system comprising:
a disc;
a transducer configured to write data to the disc; and
circuitry operably coupled to the transducer, wherein the circuitry is configured to cause the transducer to write data to a first location within a risk zone and to write a copy of the data to a second location within the risk zone.

15. The data storage system of claim 14, wherein the second location is physically apart from the first location.

16. The data storage system of claim 14, wherein the first location and the second location are located on a same surface of the disc.

17. The data storage system of claim 14, wherein the first location and the second location are arranged on opposing surfaces of the disc.

18. The data storage system of claim 14, wherein the data zone is assigned a first set of addresses to the data zone, the risk zone is assigned a second set of addresses to the risk zone, wherein each of the second set of addresses is greater than each of the first set of addresses.

19. The data storage system of claim 18, wherein the circuitry is configured to utilize the risk zone for storing data only when the data zone is fully utilized.

20. The data storage system of claim 18, wherein the circuitry is configured to utilize the risk zone for storing data before the data zone is utilized.
